(19) United States
(12) Patent Application Publication
(10) Pub. No.: US 2026/0275162 A1
(43) Pub. Date: Sep. 17, 2026

(54) POLISHING ADDITIVE AND POLISHING COMPOSITION CONTAINING SAME

(71) Applicant: NOF CORPORATION, Tokyo (JP)

(72) Inventors: Midori SUGIURA, Kawasaki-shi (JP); Takuya HONDA, Kawasaki-shi (JP)

(73) Assignee: NOF CORPORATION, Tokyo (JP)

(21) Appl. No.: 19/557,567

(22) Filed: Mar. 5, 2026

(30) Foreign Application Priority Data
Mar. 12, 2025 (JP) 2025-039140

(51) Int. Cl. C09G 1/02

(52) U.S. Cl. CPC C09G 1/02

(57) ABSTRACT

The polishing additive includes at least one compound selected from polyether-based amine compounds represented by Formula (1) and Formula (2).

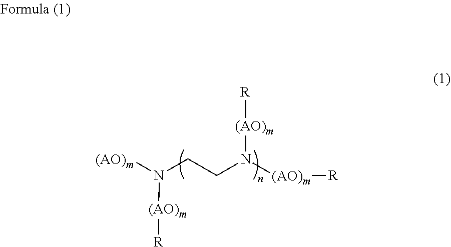

(In Formula (1), AO represents an oxyalkylene group having 2 to 4 carbon atoms, m represents an average number of moles of the oxyalkylene group added and is a number from 1 to 60, n is a number from 1 to 4, and Rs each independently represent a hydrogen atom or a hydrocarbon group having 1 to 4 carbon atoms.)

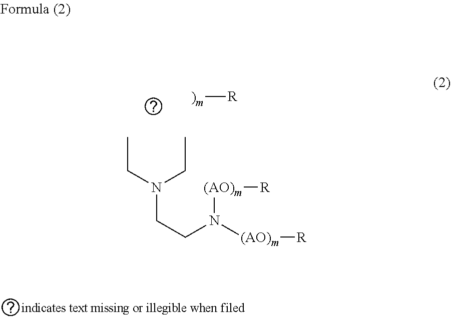

(In Formula (2), AO represents an oxyalkylene group having 2 to 4 carbon atoms, m represents an average number of moles of the oxyalkylene group added and is a number from 1 to 60, and Rs each independently represent a hydrogen atom or a hydrocarbon group having 1 to 4 carbon atoms.)

### BACKGROUND OF THE INVENTION

### Field of the Invention

The present invention relates to a polishing additive and a polishing composition containing the same, and in particular to a polishing additive and a polishing composition that are applicable to chemical mechanical polishing (CMP).

### Description of the Background Art

In development of semiconductor devices typified by semiconductor integrated circuits, higher density and higher levels of integration by miniaturization and multilayering of wirings have been recently required to achieve smaller size and higher speed. Various techniques such as CMP have been used for this purpose. CMP is an essential technique in conducting surface planarization of a film to be processed such as an interlayer insulating film, plug formation, formation of a metal wiring, and the like, and is used for smoothing of substrates, or the like.

As one of the methods for forming a metal wiring, a damascene method is known. In the damascene method, a groove for a wiring pattern is formed in an insulating film, a metal film is embedded in the groove, and unnecessary portions of the embedded metal film are removed by CMP to form a wiring.

While aluminum was mainly used for the metal wiring formed by the damascene method in the past, copper, which has a lower resistance, is used in the current situation where miniaturization of wirings has been progressing.

The polishing composition for use in the damascene method is required to have a high polishing rate for the metal film for efficient removal of the metal film. On the other hand, if the insulating film appearing after the removal of the metal film is polished and becomes too thin, there is a concern of reduction in insulating properties. Therefore, such a polishing composition is required to have a high polishing rate for the metal film and a low polishing rate for the insulating film, that is, high polishing selectivity of the metal film relative to the insulating film.

Accordingly, Patent Literature (PTL) 1 reports that a metal film can be polished with higher selectivity relative to an insulating film by using a polishing composition containing silica abrasive grains controlled to have a predetermined particle size.

### CITATION LIST

### Patent Literature

[PTL 1] Japanese Unexamined Patent Application Publication No. 2023-90715

### SUMMARY OF THE INVENTION

However, wirings have been further miniaturized due to recent downsizing and speeding up of semiconductor devices, sometimes causing the selectivity to be insufficient with the aforementioned polishing composition.

In polishing of a metal film, a polishing composition generally contains an oxidizing agent and a metal-dissolving agent, and a high polishing rate is obtained by conducting the polishing while eluting the metal. Meanwhile, additives that protect the polished surface are used to restrain polishing of an insulating film. However, if such additives inhibit the elution of the metal, the polishing rate for the metal film may also decrease. Therefore, there is a need for a polishing additive capable of enhancing the polishing selectivity of a metal film relative to an insulating film by promoting the elution of the metal while suppressing polishing of the insulating film.

The present invention has been made in light of the circumstances described above, and the problems to be solved are to provide a polishing additive capable of enhancing the polishing selectivity of a metal film relative to an insulating film, and a polishing composition containing the polishing additive.

### Solution to the Problems

The inventors of the present invention have diligently studied to solve the above problems, and found that the above problems can be solved by using a polyether-based amine compound having a specific structure. That is, the present invention relates to the following [1] and [2].

[1] A polishing additive including at least one compound selected from polyether-based amine compounds represented by the following Formula (1) and Formula (2).

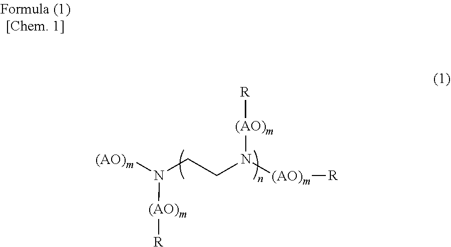

(In Formula (1), AO represents an oxyalkylene group having 2 to 4 carbon atoms, m represents an average number of moles of the oxyalkylene group added and is a number from 1 to 60, n is a number from 1 to 4, and Rs each independently represent a hydrogen atom or a hydrocarbon group having 1 to 4 carbon atoms.)

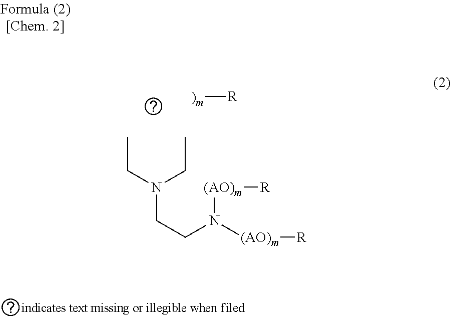

(In Formula (2), AO represents an oxyalkylene group having 2 to 4 carbon atoms, m represents an average number of moles of the oxyalkylene group added and is a number from 1 to 60, and Rs each independently represent a hydrogen atom or a hydrocarbon group having 1 to 4 carbon atoms.)

[2] A polishing composition including the polishing additive according to [1] and abrasive grains, in which the polishing composition contains 0.1 to 10 mass % of the abrasive grains and 0.01 to 10 mass % of the polyether-based amine compound.

According to the present invention, it is possible to provide a polishing additive capable of enhancing the polishing selectivity of a metal film relative to an insulating film, and a polishing composition containing the polishing additive.

### DESCRIPTION OF THE PREFERRED EMBODIMENTS

Hereinafter, embodiments of the present invention will be described sequentially.

### (Polishing Additive)

A polishing additive according to an embodiment of the present invention includes at least one compound selected from polyether-based amine compounds represented by the following Formula (1) and Formula (2). That is, the polishing additive may be at least one compound selected from polyether-based amine compounds represented by the following Formula (1) and Formula (2), or may be a composition containing the compound and other components described later.

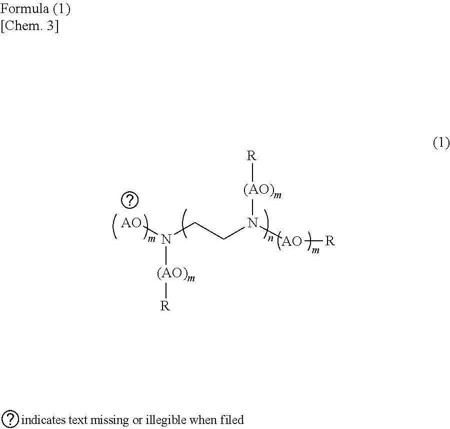

(In Formula (1), AO represents an oxyalkylene group having 2 to 4 carbon atoms, m represents an average number of moles of the oxyalkylene group added and is a number from 1 to 60, n is a number from 1 to 4, and Rs each independently represent a hydrogen atom or a hydrocarbon group having 1 to 4 carbon atoms.)

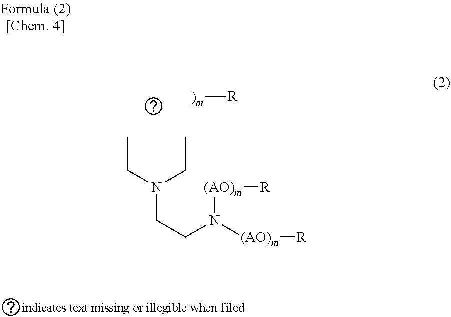

(In Formula (2), AO represents an oxyalkylene group having 2 to 4 carbon atoms, m represents an average number of moles of the oxyalkylene group added and is a number from 1 to 60, and Rs each independently represent a hydrogen atom or a hydrocarbon group having 1 to 4 carbon atoms.)

The structures of Formula (1) and Formula (2) will be described in detail below.

In Formula (1) and Formula (2), AO represents an oxyalkylene group having 2 to 4 carbon atoms, and the form of AO may be linear or branched. AO may be of one type or two or more types. When AO is of two or more types, the addition form may be random or block, and the block is preferable.

Examples of AO include an oxyethylene group (EO), an oxypropylene group (PO), and an oxybutylene group (BO). Among these, it is preferable to use one type or two or more types selected from an oxyethylene group, an oxypropylene group, and an oxybutylene group. It is more preferable to use an oxyethylene group and an oxypropylene group. A diblock structure formed of a block of oxyethylene group and a block of oxypropylene group is further preferable. If AO has the diblock structure, it is preferable that the block of oxyethylene group is bonded to N in Formula (1) and Formula (2) and the block of oxypropylene group is bonded to R in Formula (1) and Formula (2).

When two or more types of AOs are used in combination, the ratio of the types can be appropriately determined depending on the types of AOs or the like. For example, when EO and PO are used in combination, the composition ratio of EO to PO is preferably EO:PO=10:90 to 90:10, more preferably 20:80 to 80:20, and further preferably 30:70 to 70:30 in terms of molar fraction (mol %). When EO and BO are used in combination, the composition ratio of EO to BO is preferably EO:BO=70:30 to 95:5 and more preferably 80:20 to 90:10 in terms of molar fraction (mol %).

In Formula (1) and Formula (2), m represents an average number of moles of the oxyalkylene group added and is a number from 1 to 60. While m can be appropriately set depending on the type of AO or the like, m is preferably 5 to 40, more preferably 10 to 30, and further preferably 15 to 20.

In Formula (1), n is a number from 1 to 4, preferably 2 to 3, and particularly preferably 2.

In Formula (1) and Formula (2), Rs each independently represent a hydrogen atom or a hydrocarbon group having 1 to 4 carbon atoms. Examples of the hydrocarbon group include saturated hydrocarbon groups such as a methyl group, an ethyl group, a propyl group, and a butyl group, and unsaturated hydrocarbon groups such as an allyl group and a methallyl group. Among these, a hydrogen atom or a saturated hydrocarbon group having 1 to 4 carbon atoms is preferable, a hydrogen atom or a methyl group is more preferable, and a hydrogen atom is further preferable. When the number of carbon atoms of the hydrocarbon group represented by R exceeds 4, production may become difficult.

In Formula (1) and Formula (2), all Rs may be the same or Rs may be optionally different. When R is a hydrocarbon group, all Rs may be the same hydrocarbon group or Rs may be two or more types of different hydrocarbon groups.

The molecular weights of the polyether-based amine compounds represented by Formula (1) and Formula (2) are not particularly limited, but are preferably 300 to 10,000, more preferably 500 to 9,000, and further preferably 4,000 to 8,000 from the viewpoint of polishing selectivity. The molecular weights each are a value calculated from an amine value. The amine value can be measured by a method described later in the section for Examples.

The polyether-based amine compound represented by Formula (1) can be synthesized as described below, for example.

The polyether-based compound in which R in Formula (1) is a hydrogen atom can be produced by adding an alkylene oxide to a polyethylene polyamine having 2 to 5 nitrogen atoms. When a plurality of types of alkylene oxides are used, the structure of AO in Formula (1) can be controlled by, for example, adjusting the addition order of the alkylene oxides.

A catalyst may be used or need not be used in the addition reaction of alkylene oxide. Examples of the catalyst that can be used in the addition reaction of alkylene oxide include alkali catalysts, and, for example, oxides of alkali metals or alkaline earth metals, hydroxides and alcoholates of alkali metals or alkaline earth metals, alkylamines such as triethylamine, and alkanolamines such as triethanolamine can be used. In addition to the above alkali catalysts, Lewis acid catalysts such as boron trifluoride or tin tetrachloride can be used. The use amount of the catalyst is generally 0.01 to 5.0 mass % based on the mass after completion of the addition reaction.

More specifically, the addition reaction of alkylene oxide can be conducted at 50 to 200° C. and 0.02 to 1.0 MPa under an inert gas atmosphere such as argon or nitrogen gas by continuously adding a desired alkylene oxide to a desired polyethylene polyamine, which is a raw material, under pressure in the presence of a catalyst if necessary.

The polyether-based compound in which R in Formula (1) is a hydrocarbon group having 1 to 4 carbon atoms can be produced by adding an alkylene oxide to a polyethylene polyamine having 2 to 5 nitrogen atoms, and then, if necessary, reacting a halogenated hydrocarbon such as an alkyl halide or an alkenyl halide having 1 to 4 carbon atoms in the presence of an alkali catalyst to alkylate or alkenylate the hydroxyl terminals of the oxyalkylene groups.

Examples of the alkyl halide include methyl chloride, ethyl chloride, propyl chloride, butyl chloride, methyl bromide, ethyl bromide, methyl iodide, and ethyl iodide. Examples of the alkenyl halide include allyl chloride and methallyl chloride.

Examples of the alkali catalyst that is applicable to the reaction of the halogenated hydrocarbon include oxides of alkali metals or alkaline earth metals, and hydroxides and alcoholates of alkali metals or alkaline earth metals.

The charge amount of the halogenated hydrocarbon is usually 100 to 400 mol % with respect to the hydroxyl group to be reacted, and the charge amount of the alkali catalyst is usually 100 to 500 mol % with respect to the hydroxyl groups to be reacted. The reaction temperature is generally 60 to 180° C.

The polyether-based amine compound represented by Formula (2) can be synthesized as described below, for example.

The polyether-based compound in which R in Formula (2) is a hydrogen atom can be produced by adding an alkylene oxide to aminoethylpiperazine. When a plurality of types of alkylene oxides are used, the structure of AO in Formula (2) can be controlled by adjusting the addition order of the alkylene oxides. The various conditions may be the same as those for the polyether-based amine compound represented by Formula (1).

The polyether-based compound in which R in Formula (2) is a hydrocarbon group having 1 to 4 carbon atoms can be produced by adding an alkylene oxide to aminoethylpiperazine, and then, if necessary, reacting a halogenated hydrocarbon such as an alkyl halide or an alkenyl halide, which have 1 to 4 carbon atoms, in the presence of an alkali catalyst to alkylate or alkenylate the hydroxyl terminals of the oxyalkylene groups. Various conditions may be the same as those for the polyether-based amine compound represented by Formula (1).

The polishing additive according to the embodiment of the present invention may contain other components in addition to the polyether-based amine compound represented by the aforementioned Formula (1) or Formula (2) if necessary, as long as the effect of the present invention is not impaired. Examples of such other components include an acid and a solvent. The acid is used as necessary for the purpose of neutralizing the polyether-based amine compound. The applicable acid may be any of organic acids and inorganic acids, and one type or two or more types selected from organic acids and inorganic acids may be used.

Examples of organic acids include acetic acid, glycolic acid, oxalic acid, citric acid, lactic acid, and malic acid. Examples of inorganic acids include hydrochloric acid, nitric acid, sulfuric acid, and phosphoric acid.

The type of the solvent can be appropriately selected in accordance with the object to be polished and the like. In the case of CMP, water such as ion exchanged water or ultrapure water is suitable.

### (Polishing Composition)

A polishing composition according to an embodiment of the present invention contains the aforementioned polishing additive and abrasive grains. The content of the polishing additive as the aforementioned polyether-based amine compound is 0.01 to 10 mass % in the polishing composition. The content of the abrasive grains is 0.1 to 10 mass % in the polishing composition.

The abrasive grains that can be used may be appropriately selected in accordance with the object to be polished. For example, when used for CMP, abrasive grains generally used in CMP can be appropriately selected in accordance with the object to be polished, and examples of such abrasive grains include particles of alumina, ceria (cerium oxide), colloidal silica, manganese oxide, and the like. The size of the abrasive grains may be a size generally used in this technical field, and for example, particles having an average particle diameter of 10 to 1,000 nm may be appropriately selected in accordance with the intended use and the like.

The polishing composition according to the embodiment may further contain other components in addition to the aforementioned polishing additive and abrasive grains as long as the functions of the respective components are not hindered. Examples of such other components include a dispersion medium, a dispersant, a pH regulator, a surfactant, a defoaming agent, an oxidizing agent, an organic acid, and an anticorrosive agent.

The dispersion medium that can be used may be appropriately selected in accordance with the intended use and the like. For example, an aqueous solvent or an organic solvent is applicable. Examples of the aqueous solvent include water such as ion exchanged water and ultrapure water. Examples of the organic solvent include an aromatic hydrocarbon-based solvent, an aliphatic hydrocarbon-based solvent, a ketone-based solvent, an ester-based solvent, a glycol ether-based solvent, a terpene-based solvent, and an alcohol-based solvent. When used for CMP, an aqueous solvent is preferable, and water is more preferable. The content of the dispersion medium is preferably 75 to 99.8 mass % in the polishing composition. When the polishing additive contains a solvent in advance and another solvent (dispersion medium) is separately added, the amount of the separately added solvent (dispersion medium) is adjusted so that the total amount of the solvent contained in the polishing additive and the separately added solvent (dispersion medium) falls in 75 to 99.8% mass %.

As the dispersant, a general dispersant capable of dispersing abrasive grains in the polishing composition may be appropriately selected in accordance with the type of the abrasive grains and the like. Examples of the dispersant include an anionic dispersant, a nonionic dispersant, a cationic dispersant, and an amphoteric dispersant. When used for CMP, the dispersant is preferably water-soluble.

Specific examples of the dispersant include: phosphate compounds; hydrogen phosphate compounds; homopolymers of unsaturated carboxylic acids such as acrylic acid, methacrylic acid, maleic acid, fumaric acid, and itaconic acid (polyacrylic acid, etc.); ammonium salts or amine salts of these polymers; copolymers of unsaturated carboxylic acids such as acrylic acid, methacrylic acid, maleic acid, fumaric acid, and itaconic acid with monomers such as alkyl acrylates (methyl acrylate, ethyl acrylate, etc.), hydroxyalkyl acrylates (hydroxyethyl acrylate, etc.), alkyl methacrylates (methyl methacrylate, ethyl methacrylate, etc.), hydroxyalkyl methacrylates (hydroxyethyl methacrylate, etc.), vinyl acetate, and vinyl alcohol (copolymers of acrylic acid and alkyl acrylates, etc.); and ammonium salts or amine salts of these copolymers.

One type of the dispersant may be used alone, or two or more types of the dispersants may be used in combination.

The content of the dispersant is preferably 0.1 to 10 parts by mass in terms of solid content with respect to 100 parts by mass of the abrasive grains.

The oxidizing agent may be appropriately selected in accordance with the object to be polished. Examples of such an oxidizing agent include ammonium persulfate, potassium persulfate, hydrogen peroxide, ferric nitrate, and ammonium cerium nitrate. One type of the oxidizing agent may be used alone, or two or more types of the oxidizing agents may be used in combination. The content of the oxidizing agent is preferably 0.01 to 5 mass % in the polishing composition.

As the organic acid, those having an oxidation-inhibiting effect may be used. Examples of the organic acid having such a function include quinaldic acid, quinolinic acid, malonic acid, oxalic acid, and succinic acid. The content of the organic acid is preferably 0.01 to 5 mass % in the polishing composition.

The properties of the polishing composition can be appropriately adjusted by the composition of components contained in consideration of the intended use and the like. In general, the polishing composition is slurry.

The polishing composition according to the embodiment can be prepared by a known method. Examples of the method include a method of adding the aforementioned abrasive grains and polishing additive, and other components as needed into a vessel and then conducting a dispersion treatment at room temperature. The addition order of the components is not particularly limited. As a dispersing machine for conducting the dispersion treatment, a known dispersing machine may be used. Examples of the dispersing machine include a roll mill, a ball mill, a bead mill, a sand mill, a homogenizer, a disperser, and a planetary centrifugal mixer. The dispersion treatment may also be conducted in an ultrasonic bath.

The polishing composition described above can be widely used as a polishing slurry for use in CMP. In particular, since the polishing composition contains the aforementioned polishing additive, the polishing composition is suitable as a polishing slurry for polishing insulating materials, metal materials, and various substrates composed of these materials.

Examples of applicable insulating materials include a silicon-based insulating material and an organic polymer-based insulating material. Examples of the silicon-based insulating material include silicon oxide and silicon nitride. As the applicable metal material, for example, aluminum, copper, tungsten, cobalt, and ruthenium are preferable, and copper is particularly preferable.

Examples of applicable substrates include substrates to be applied to a wiring formation process by the damascene method. A specific example of such a substrate is a substrate composed of an insulating material and a metal material provided on the insulating material. Since the polishing composition contains the aforementioned polishing additive, and thus has excellent polishing selectivity of a metal film relative to an insulating film, the polishing composition is suitable as a polishing slurry for use in a wiring formation process by the damascene method.

### EXAMPLES

Next, embodiments according to the present invention will be described in more detail based on Examples.

### (Measurement of Amine Value)

The method for measuring the amine values of polyether-based compounds 1 to 8 synthesized in Examples 1 to 8 below is as follows.

Each sample of the polyether-based compounds 1 to 6 was weighed in a beaker, and neutral ethanol (ethyl alcohol (99.5 V/V %) neutralized with an N/2 hydrochloric acid standard solution using a bromocresol green indicator immediately before use) was added thereto to dissolve the sample. Then, several drops of a bromocresol green indicator were added, the solution was titrated with an N/2 hydrochloric acid standard solution, and the time when the liquid turned yellow from green was determined as an end point. The amine value was calculated according to the following formula.

$$Amine value = ( 28.05 \times F \times A ) / W$$

where A: use amount of N/2 hydrochloric acid standard solution (mL), F: factor of N/2 hydrochloric acid standard solution, and W: amount of sample taken (g).

### Example 1: Synthesis of Polyether-Based Amine Compound 1

A 5-liter stainless steel pressure vessel equipped with a stirrer, a pressure gauge, a thermometer, a safety valve, a gas blowing tube, an exhaust tube, a cooling coil, and a steam jacket was charged with 103.2 g (1 mol) of diethylenetriamine (trade name: DETA, manufactured by Tosoh Corporation), and the inside of the system was purged with nitrogen gas. After the temperature was raised to 120° C. under stirring, 220.3 g (5 mol) of ethylene oxide was added from a separately prepared pressure vessel under the condition of 120° C. and 0.05 to 0.50 MPa (gauge pressure) through the gas blowing tube while the ethylene oxide was pressurized with nitrogen gas. After completion of the addition, the reaction was allowed to proceed under the same condition until the internal pressure became constant. After cooling to 40° C., 11.8 g of potassium hydroxide was added, and the inside of the system was purged with nitrogen gas. Then, 1431.6 g (32.5 mol) of ethylene oxide was added in the same manner as described above, and after completion of the addition, the reaction was allowed to proceed under the same condition until the internal pressure became constant. Then, 2178.8 g (37.5 mol) of propylene oxide was added in the same manner as described above, and after completion of the addition, the reaction was allowed to proceed under the same condition until the internal pressure became constant. After cooling to 30° C., the reaction product was taken out from the pressure vessel, neutralized with hydrochloric acid to bring the pH to 9 to 10, and treated under reduced pressure at 100° C. for 1 hour to remove the contained water. Finally, salts were removed by filtration to obtain a polyether-based amine compound 1. The obtained polyether-based compound 1 had an amine value of 35.1, and a molecular weight determined from the amine value was 4,796.

### Example 2: Synthesis of Polyether-Based Amine Compound 2

A 5-liter stainless steel pressure vessel equipped with a stirrer, a pressure gauge, a thermometer, a safety valve, a gas blowing tube, an exhaust tube, a cooling coil, and a steam jacket was charged with 103.2 g (1 mol) of diethylenetriamine (trade name: DETA, manufactured by Tosoh Corporation), and the inside of the system was purged with nitrogen gas. After the temperature was raised to 120° C. under stirring, 220.3 g (5 mol) of ethylene oxide was added from a separately prepared pressure vessel under the condition of 120° C. and 0.05 to 0.50 MPa (gauge pressure) through the gas blowing tube while the ethylene oxide was pressurized with nitrogen gas. After completion of the addition, the reaction was allowed to proceed under the same condition until the internal pressure became constant. After cooling to 40° C., 10.2 g of potassium hydroxide was added, and the inside of the system was purged with nitrogen gas. Then, 3083.5 g (70 mol) of ethylene oxide was added in the same manner as described above, and after completion of the addition, the reaction was allowed to proceed under the same condition until the internal pressure became constant. After cooling to 30° C., the reaction product was taken out from the pressure vessel, neutralized with hydrochloric acid to bring the pH to 9 to 10, and treated under reduced pressure at 100° C. for 1 hour to remove the contained water. Finally, salts were removed by filtration to obtain a polyether-based amine compound 2. The obtained polyether-based compound 2 had an amine value of 45.0, and a molecular weight determined from the amine value was 3,740.

### Example 3: Synthesis of Polyether-Based Amine Compound 3

A 5-liter stainless steel pressure vessel equipped with a stirrer, a pressure gauge, a thermometer, a safety valve, a gas blowing tube, an exhaust tube, a cooling coil, and a steam jacket was charged with 51.6 g (0.5 mol) of diethylenetriamine (trade name: DETA, manufactured by Tosoh Corporation), and the inside of the system was purged with nitrogen gas. After the temperature was raised to 120° C. under stirring, 110.1 g (2.5 mol) of ethylene oxide was added from a separately prepared pressure vessel under the condition of 120° C. and 0.05 to 0.50 MPa (gauge pressure) through the gas blowing tube while the ethylene oxide was pressurized with nitrogen gas. After completion of the addition, the reaction was allowed to proceed under the same condition until the internal pressure became constant. After cooling to 40° C., 9.7 g of potassium hydroxide was added, and the inside of the system was purged with nitrogen gas. Then, 1266.4 g (28.8 mol) of ethylene oxide was added in the same manner as described above, and after completion of the addition, the reaction was allowed to proceed under the same condition until the internal pressure became constant. Then, 1815.6 g (31.3 mol) of propylene oxide was added in the same manner as described above, and after completion of the addition, the reaction was allowed to proceed under the same condition until the internal pressure became constant. After cooling to 30° C., the reaction product was taken out from the pressure vessel, neutralized with hydrochloric acid to bring the pH to 9 to 10, and treated under reduced pressure at 100° C. for 1 hour to remove the contained water. Finally, salts were removed by filtration to obtain a polyether-based amine compound 3. The obtained polyether-based compound 3 had an amine value of 21.1, and a molecular weight determined from the amine value was 7,978.

### Example 4: Synthesis of Polyether-Based Amine Compound 4

A 5-liter stainless steel pressure vessel equipped with a stirrer, a pressure gauge, a thermometer, a safety valve, a gas blowing tube, an exhaust tube, a cooling coil, and a steam jacket was charged with 309.5 g (3 mol) of diethylenetriamine (trade name: DETA, manufactured by Tosoh Corporation), and the inside of the system was purged with nitrogen gas. After the temperature was raised to 120° C. under stirring, 3303.8 g (75 mol) of ethylene oxide was added from a separately prepared pressure vessel under the condition of 120° C. and 0.05 to 0.50 MPa (gauge pressure) through the gas blowing tube while the ethylene oxide was pressurized with nitrogen gas. After completion of the addition, the reaction was allowed to proceed under the same condition until the internal pressure became constant. After cooling to 30° C., the reaction product was taken out from the pressure vessel, neutralized with hydrochloric acid to bring the pH to 9 to 10, and treated under reduced pressure at 100° C. for 1 hour to remove the contained water. Finally, salts were removed by filtration to obtain a polyether-based amine compound 4. The obtained polyether-based compound 4 had an amine value of 227, and a molecular weight determined from the amine value was 742.

### Example 5: Synthesis of Polyether-Based Amine Compound 5

A 5-liter stainless steel pressure vessel equipped with a stirrer, a pressure gauge, a thermometer, a safety valve, a gas blowing tube, an exhaust tube, a cooling coil, and a steam jacket was charged with 117.0 g (0.8 mol) of triethylenetetramine (trade name: TETA, manufactured by Tosoh Corporation), and the inside of the system was purged with nitrogen gas. After the temperature was raised to 120° C. under stirring, 211.4 g (4.8 mol) of ethylene oxide was added from a separately prepared pressure vessel under the condition of 120° C. and 0.05 to 0.50 MPa (gauge pressure) through the gas blowing tube while the ethylene oxide was pressurized with nitrogen gas. After completion of the addition, the reaction was allowed to proceed under the same condition until the internal pressure became constant. After cooling to 40° C., 11.4 g of potassium hydroxide was added, and the inside of the system was purged with nitrogen gas. Then, 1374.4 g (31.2 mol) of ethylene oxide was added in the same manner as described above, and after completion of the addition, the reaction was allowed to proceed under the same condition until the internal pressure became constant. Then, 2091.6 g (36 mol) of propylene oxide was added in the same manner as described above, and after completion of the addition, the reaction was allowed to proceed under the same condition until the internal pressure became constant. After cooling to 30° C., the reaction product was taken out from the pressure vessel, neutralized with hydrochloric acid to bring the pH to 9 to 10, and treated under reduced pressure at 100° C. for 1 hour to remove the contained water. Finally, salts were removed by filtration to obtain a polyether-based amine compound 5. The obtained polyether-based compound 5 had an amine value of 47.3, and a molecular weight determined from the amine value was 4,743.

### Example 6: Synthesis of Polyether-Based Amine Compound 6

A 5-liter stainless steel pressure vessel equipped with a stirrer, a pressure gauge, a thermometer, a safety valve, a gas blowing tube, an exhaust tube, a cooling coil, and a steam jacket was charged with 193.8 g (1.5 mol) of 2-aminoethylpiperazine (manufactured by Tokyo Chemical Industry Co., Ltd.), and the inside of the system was purged with nitrogen gas. After the temperature was raised to 120° C. under stirring, 198.2 g (4.5 mol) of ethylene oxide was added from a separately prepared pressure vessel under the condition of 120° C. and 0.05 to 0.50 MPa (gauge pressure) through the gas blowing tube while the ethylene oxide was pressurized with nitrogen gas. After completion of the addition, the reaction was allowed to proceed under the same condition until the internal pressure became constant. After cooling to 40° C., 10.9 g of potassium hydroxide was added, and the inside of the system was purged with nitrogen gas. Then, 1288.5 g (29.3 mol) of ethylene oxide was added in the same manner as described above, and after completion of the addition, the reaction was allowed to proceed under the same condition until the internal pressure became constant. Then, 1960.9 g (33.8 mol) of propylene oxide was added in the same manner as described above, and after completion of the addition, the reaction was allowed to proceed under the same condition until the internal pressure became constant. After cooling to 30° C., the reaction product was taken out from the pressure vessel, neutralized with hydrochloric acid to bring the pH to 9 to 10, and treated under reduced pressure at 100° C. for 1 hour to remove the contained water. Finally, salts were removed by filtration to obtain a polyether-based amine compound 6. The obtained polyether-based compound 6 had an amine value of 69.3, and a molecular weight determined from the amine value was 2,428.

### Example 7: Synthesis of Polyether-Based Amine Compound 7

A 5-liter stainless steel pressure vessel equipped with a stirrer, a pressure gauge, a thermometer, a safety valve, a gas blowing tube, an exhaust tube, a cooling coil, and a steam jacket was charged with 479.6 g (0.1 mol) of the polyether-based amine compound 1 and 100.7 g of potassium hydroxide, and the inside of the system was purged with nitrogen gas. Under stirring, 40.3 g of methyl chloride was injected under pressure at 80 to 130° C., and the reaction was allowed to proceed until the internal pressure became constant. After cooling to 30° C., the reaction product was taken out from the pressure vessel, neutralized with hydrochloric acid to bring the pH to 9 to 10, and treated under reduced pressure at 100° C. for 1 hour to remove the contained water. Finally, salts were removed by filtration to obtain a polyether-based amine compound 7. The obtained polyether-based compound 7 had an amine value of 34.5, and a molecular weight determined from the amine value was 4,879.

### Example 8: Synthesis of Polyether-Based Amine Compound 8

A 5-liter stainless steel pressure vessel equipped with a stirrer, a pressure gauge, a thermometer, a safety valve, a gas blowing tube, an exhaust tube, a cooling coil, and a steam jacket was charged with 103.2 g (1 mol) of diethylenetriamine (trade name: DETA, manufactured by Tosoh Corporation), and the inside of the system was purged with nitrogen gas. After the temperature was raised to 120° C. under stirring, 220.3 g (5 mol) of ethylene oxide was added from a separately prepared pressure vessel under the condition of 120° C. and 0.05 to 0.50 MPa (gauge pressure) through the gas blowing tube while the ethylene oxide was pressurized with nitrogen gas. After completion of the addition, the reaction was allowed to proceed under the same condition until the internal pressure became constant. After cooling to 40° C., 11.8 g of potassium hydroxide was added, and the inside of the system was purged with nitrogen gas. Then, 2532.9 g (57.5 mol) of ethylene oxide was added in the same manner as described above, and after completion of the addition, the reaction was allowed to proceed under the same condition until the internal pressure became constant. Then, 901.4 g (12.5 mol) of butylene oxide was added in the same manner as described above, and after completion of the addition, the reaction was conducted under the same condition until the internal pressure became constant. After cooling to 30° C., the reaction product was taken out from the pressure vessel, neutralized with hydrochloric acid to bring the pH to 9 to 10, and treated under reduced pressure at 100° C. for 1 hour to remove the contained water. Finally, salts were removed by filtration to obtain a polyether-based amine compound 8. The obtained polyether-based compound 8 had an amine value of 41.2, and a molecular weight determined from the amine value was 4,086.

The configurations of the polyether-based amine compounds 1 to 8 obtained in Examples 1 to 8 are shown in Table 1.

TABLE 1

| | | | Mole | Mole | Mole | | | |
|---|---|---|---|---|---|---|---|---|
| | | | number | number | number | | | |
| | | | of | of | of | | | |
| | | | added | added | added | | | |
| Polishing additive | Formula | Form of added AO | EO | PO | BO | m | n | R |
| Polyether-based | (1) | EO, PO block | 7.5 | 7.5 | — | 15 | 2 | Hydrogen atom |
| amine compound 1 | | | | | | | | |
| Polyether-based | (1) | EO homo | 15 | — | — | 15 | 2 | Hydrogen atom |
| amine compound 2 | | | | | | | | |
| Polyether-based | (1) | EO, PO block | 12.5 | 12.5 | — | 25 | 2 | Hydrogen atom |
| amine compound 3 | | | | | | | | |
| Polyether-based | (1) | EO homo | 5 | — | — | 5 | 2 | Hydrogen atom |
| amine compound 4 | | | | | | | | |
| Polyether-based | (1) | EO, PO block | 7.5 | 7.5 | — | 15 | 3 | Hydrogen atom |
| amine compound 5 | | | | | | | | |
| Polyether-based | (2) | EO, PO block | 7.5 | 7.5 | — | 15 | — | Hydrogen atom |
| amine compound 6 | | | | | | | | |
| Polyether-based | (1) | EO, PO block | 7.5 | 7.5 | — | 15 | 2 | Methyl group |
| amine compound 7 | | | | | | | | |
| Polyether-based | (1) | EO, BO block | 12.5 | — | 2.5 | 15 | 2 | Hydrogen atom |
| amine compound 8 | | | | | | | | |

### Comparative Example 1

Polyethylene glycol (molecular weight 2000) was used in place of a polyether-based amine compound.

### Comparative Example 2

Diethylenetriamine (trade name: DETA, manufactured by Tosoh Corporation) was used in place of a polyether-based amine compound.

### Evaluation of Elution of Copper

### <Preparation of Solution for Elution Test>

Ingredients were mixed so that the resultant mixture contained 0.3 mass % of hydrogen peroxide, 0.1 mass % of malonic acid, and 0.1 mass % of one of polyether-based amine compounds of Examples 1 to 8 or compounds of Comparative Examples 1 and 2 as a polishing additive, with the balance being ion exchanged water. For the obtained mixture, pH was adjusted to 2±0.5 with nitric acid to prepare Solutions 1 to 10 for elution test. Since polishing was not conducted, abrasive grains were not blended in the solutions for elution test. Table 2 shows the compositions of Solutions 1 to 10.

TABLE 2

| | Example 1 | Example 2 | Example 3 | Example 4 | Example 5 | Example 6 |
|---|---|---|---|---|---|---|
| Name of solution | Solution 1 | Solution 2 | Solution 3 | Solution 4 | Solution 5 | Solution 6 |
| for elution test | | | | | | |
| Hydrogen peroxide | 0.3 | | | | | |
| (mass %) | | | | | | |
| Malonic acid | 0.1 | | | | | |
| (mass %) | | | | | | |
| Ion exchanged | Balance | | | | | |
| water (mass %) | | | | | | |
| Polishing additive | Polyether- | Polyether- | Polyether- | Polyether- | Polyether- | Polyether- |
| | based amine | based amine | based amine | based amine | based amine | based amine |
| | compound 1 | compound 2 | compound 3 | compound 4 | compound 5 | compound 6 |
| Polishing additive | 0.1 | | | | | |
| (mass %) | | | | | | |

| | | | Comparative | Comparative |
|---|---|---|---|---|
| | Example 7 | Example 8 | Example 1 | Example 2 |
| Name of solution | Solution 7 | Solution 8 | Solution 9 | Solution 10 |
| for elution test | | | | |
| Hydrogen peroxide | 0.3 | | | |
| (mass %) | | | | |
| Malonic acid | 0.1 | | | |
| (mass %) | | | | |
| Ion exchanged | Balance | | | |
| water (mass %) | | | | |
| Polishing additive | Polyether- | Polyether- | Polyethylene | Diethylenetriamine |
| | based amine | based amine | glycol | |
| | compound 7 | compound 8 | | |
| Polishing additive | 0.1 | | | |
| (mass %) | | | | |

### <Elution Test>

Copper plates cut into a size of 1×2 cm were respectively immersed in Solutions 1 to 10 for elution test and allowed to stand at room temperature for 2 hours, and then the copper plates were taken out and washed. The weight of each copper plate was measured before and after immersion using a microelectronic balance BM-20 (manufactured by A&D Company, Limited). The elution amount of copper was calculated according to the following formula.

Elution amount of copper (wt %)=[weight of copper plate before immersion (g)−weight of copper plate after immersion (g)]/weight of copper plate before immersion (g)×100

Elution of copper was evaluated according to the following criteria.

Excellent: Elution amount is 0.9 wt % or more.

Good: Elution amount is 0.6 wt % or more and less than 0.9 wt %.

Poor: Elution amount is less than 0.6 wt %.

### (Polishing Evaluation)

### <Preparation of Slurry for Polishing Evaluation>

Ultrapure water was added to a colloidal silica abrasive (COMPOL 80, manufactured by MUSASHINO DENSHI, INC., solvent: water) to adjust the concentration of powder (silica as abrasive grains) to 5 mass %, and one of the polyether-based amine compounds of Examples 1 to 8 or the compounds of Comparative Examples 1 and 2 was added as a polishing additive so that the concentration of the compound was 0.1 mass % in a slurry for polishing evaluation (polishing composition) to prepare the slurry for polishing evaluation.

### <Polishing Test>

From a 12-inch silicon wafer on which a silicon oxide (SiO₂) film having a thickness of 2000 nm was formed on both sides, a test piece of 20 mm×20 mm was cut out to obtain a test piece of silicon oxide film.

As a polishing device, MA-200e manufactured by MUSASHINO DENSHI, INC. was used. As a polishing pad, IC1000 (manufactured by NITTA DuPont Incorporated) was used. The polishing pad was attached to the platen of the polishing device, the test piece was set on a polishing holder, and the polishing holder was placed on the polishing pad. Furthermore, a weight was placed on the polishing holder so that the pressure applied to the test piece was 7.5 kPa. The test piece was polished by rotating the platen and the polishing holder in the same rotational direction at 120 rpm/min for 5 minutes while dropping the slurry for polishing evaluation onto the center of the polishing pad at a rate of 10 mL/min. After the polishing, the test piece was washed with ultrapure water and dried with nitrogen gas.

The weight of the test piece was measured before and after polishing using a microelectronic balance BM-20 (manufactured by A&D Company, Limited). The polishing rate of the silicon oxide film was calculated according to the following formula.

$$Polishing rate of silicon oxide film ( nm / min ) = [ weight of test piece before polishing ( g ) - weight of test piece after polishing ( g ) ] / density of silicon oxide ( {cm}^{3} / g ) / area of test piece ( {cm}^{2} ) / polishing time ( min ) / 10000000$$

The polishing rate was evaluated according to the following criteria.

Excellent: Polishing rate is less than 10 nm/min

Good: Polishing rate is 10 nm/min or more and less than 15 nm/min

Poor: Polishing rate is 15 nm/min or more

The evaluation results are shown in Table 3. In Table 3, the left column of each evaluation item shows the calculated value, and the units of the values are as described above.

TABLE 3

| | Elution amount of copper | | Polishing rate of SiO₂ film | |
|---|---|---|---|---|
| | Elution amount | | Polishing rate | |
| | (wt %) | Evaluation | (nm/min) | Evaluation |
| Example 1 | 0.93 | Excellent | 9.3 | Excellent |
| Example 2 | 0.91 | Excellent | 11.6 | Good |
| Example 3 | 0.80 | Good | 9.8 | Excellent |
| Example 4 | 0.72 | Good | 13.3 | Good |
| Example 5 | 0.88 | Good | 9.8 | Excellent |
| Example 6 | 0.81 | Good | 11.1 | Good |
| Example 7 | 0.91 | Excellent | 11.2 | Good |
| Example 8 | 0.85 | Good | 10.2 | Good |
| Comparative | 0.48 | Poor | 10.2 | Good |
| Example 1 | | | | |
| Comparative | 1.35 | Excellent | 16.1 | Poor |
| Example 2 | | | | |

From Table 3, the following points are demonstrated.

When the polyether-based amine compounds 1 to 8 obtained in Examples 1 to 8 were used as a polishing additive, the elution amount of copper was larger than that obtained when the polyethylene glycol of Comparative Example 1 was used as a polishing additive, indicating that polishing of a copper film can be promoted.

Further, when the polyether-based amine compounds 1 to 8 were used as a polishing additive, the polishing rate of the silicon oxide film was smaller than that obtained when the diethylenetriamine of Comparative Example 2 was used as a polishing additive.

These results demonstrate that a polishing composition containing a predetermined polyether-based amine compound as a polishing additive can promote polishing of a metal film by promoting the elution of the metal film, and can enhance the polishing selectivity of the metal film relative to an insulating film because the polishing rate of the insulating film is small. Therefore, the polishing composition is suitable, for example, as a polishing slurry for use in CMP. The polishing additive is also effective as a constituent component of the polishing composition.

What is claimed is:

1. A polishing additive comprising at least one compound selected from polyether-based amine compounds represented by Formula (1) and Formula (2), 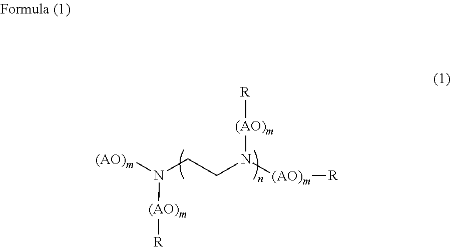
(in Formula (1), AO represents an oxyalkylene group having 2 to 4 carbon atoms, m represents an average number of moles of the oxyalkylene group added and is a number from 1 to 60, n is a number from 1 to 4, and Rs each independently represent a hydrogen atom or a hydrocarbon group having 1 to 4 carbon atoms.) 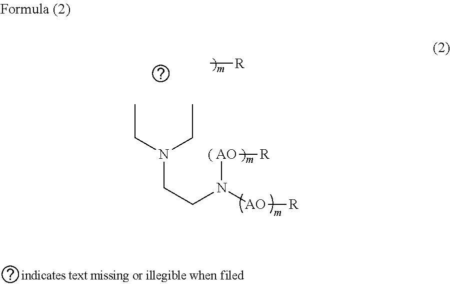
(in Formula (2), AO represents an oxyalkylene group having 2 to 4 carbon atoms, m represents an average number of moles of the oxyalkylene group added and is a number from 1 to 60, and Rs each independently represent a hydrogen atom or a hydrocarbon group having 1 to 4 carbon atoms.)

2. A polishing composition comprising the polishing additive according to claim 1 and abrasive grains, wherein
the polishing composition contains 0.1 to 10 mass % of the abrasive grains and 0.01 to 10 mass % of the polyether-based amine compound.
